(19) United States
(12) Patent Application Publication
(10) Pub. No.: US 2024/0046395 A1
(43) Pub. Date: Feb. 8, 2024

(54) Distributed Subscriber Status Monitoring for a Provider of Subsidized Connectivity Services

(71) Applicant: Maxsip Tel LLC, Woodmere, NY (US)

(72) Inventor: Israel Max, Woodmere, NY (US)

(73) Assignee: Maxsip Tel LLC, Woodmere, NY (US)

(21) Appl. No.: 18/230,155

(22) Filed: Aug. 3, 2023

Related U.S. Application Data
(60) Provisional application No. 63/394,659, filed on Aug. 3, 2022.

(51) Int. Cl. G06Q 50/26; G06Q 20/10; G06Q 20/40

(52) U.S. Cl. CPC G06Q 50/26; G06Q 20/10; G06Q 20/40

(57) ABSTRACT

Some embodiments relate to methods, systems, and devices for a provider of government-subsidized connectivity services (such as subsidized broadband connectivity; e.g., high-speed internet access) to automatically monitor the status of its subscribers in the government-subsidized connectivity services program, and to automatically and selectively re-enroll subscribers to receive the government-subsidized connectivity services through the provider in the event that the monitored status indicates that the subscriber is no longer enrolled to receive the government-subsidized connectivity services from the provider, such as if the subscriber has been de-enrolled from the government-subsidized connectivity service program, or if the subscriber has been transferred to a different provider of the government-subsidized connectivity service.

### RELATED APPLICATIONS

This application claims the benefit of U.S. Provisional Application No. 63/394,659, filed Aug. 3, 2022, which is hereby incorporated herein by reference in its entirety.

### BACKGROUND

Some embodiments described in the present disclosure generally relate to systems and methods for a provider of government-subsidized connectivity services (such as subsidized broadband connectivity; e.g., high-speed internet access) to automatically monitor the status of its subscribers in the government-subsidized connectivity services program, and to automatically and selectively re-enroll subscribers to receive the government-subsidized connectivity services through the provider in the event that the monitored status indicates that the subscriber is no longer enrolled to receive the government-subsidized connectivity services from the provider, such as if the subscriber has been de-enrolled from the government-subsidized connectivity service program, or if the subscriber has been transferred to a different provider of the government-subsidized connectivity service.

There are a number of different government programs that provide subsidies to households and/or individuals having income below certain thresholds, or otherwise meet criterion for participating in the government programs. For example, the Affordable Connectivity Program (ACP) is a Federal Communication Commission (FCC) benefit program that help families and households struggling to afford internet service. The benefit provides a discount of up to $30 per month toward internet service for eligible households and up to $75 per month for households on qualifying Tribal lands. The program also provides one device discount on a laptop, tablet, or desktop computer. Eligible households can receive a one-time discount of up to $100 to purchase a laptop, desktop computer, smart phone, or tablet from participating providers if they contribute more than $10 and less than $50 toward the purchase price. As another example, Lifeline program is a federal program that lowers the monthly cost of phone or internet service. The Lifeline program provides up to a $9.25 monthly discount on phone or internet service, and up to $34.25/month tribal discount.

These programs help connect eligible households to jobs, critical healthcare services, virtual classrooms, and more online. The benefits provided by these programs can often improve the quality of life for eligible households. In particular, benefits that provide eligible households with subsidized or free access to telecommunications services can often improve the quality of life for participants by lowering the burden for accessing websites, apps and social media platforms and staying connected to friends and family.

Generally, enrolling in a government-subsidized connectivity program, such as ACP, may involve two steps: (i) an individual or household (each of which may be referred to herein as a “consumer”) applying to the government to confirm or obtain verification of eligibility for the program; and (ii) once verified as eligible (“qualified”) for the program, becoming enrolled in the program through a program-participating service provider. For instance, a consumer may first apply directly with the government to verify eligibility, and then separately contact a program-participating provider, which will complete the enrollment process on behalf of the consumer, and then commence providing the government-subsidized connectivity service to the consumer. Alternatively, in addition to the subsequent enrollment in the program once the verification process has been successfully completed, some program-participating service providers may assist consumers in completing the initial verification (qualification) process.

By way of example, for the FCC's ACP, a consumer must provide certain personal (e.g., identity and income) information to the government (e.g., via an online FCC portal), which upon confirming the consumer's eligibility for the program, adds the consumer to the National Verifier (NV) database (“the NV”). To enroll a consumer in the program as its subscriber, a service provider may access the NV to confirm the consumer's eligibility; and if the consumer is eligible, the service provider proceeds with enrolling the consumer in the program by enrolling the consumer in the National Lifeline Accountability Database (NLAD) by providing (e.g., via subscriber-file upload, or via an NLAD API) certain subscriber and related information identifying the consumer (e.g., including personal identifying information (PII) as it appears in the NV), along with service-provider identifying information (e.g., the Study Area Code (SAC)). Before successfully enrolling the subscriber presented for enrollment by the service provider, NLAD separately confirms, for example, that the subscriber is NV-qualified (i.e. the subscriber is in the NV), that the subscriber information (e.g., PII) received for enrollment matches the information in the NV, and that the subscriber does not already exist in NLAD (e.g., that there is no so-called duplicate subscriber error). (For clarity, it is noted that the NV and NLAD have been implemented, and are operated and managed, by the Universal Service Administration Company (USAC), an independent, not-for-profit entity designated by the FCC to administer the Universal Service Fund (USF).)

Once enrolled in the ACP (i.e., enrolled in NLAD as an ACP subscriber/consumer) and receiving connectivity services from a given ACP service provider, there are various circumstances that may result in the ACP subscriber no longer being enrolled to receive the subsidized connectivity service through the given ACP service provider.

For instance, in some of these circumstances, the subscriber may be de-enrolled from the program, though remaining a subscriber of the given service provider, which may continue to provide connectivity services to the subscriber (even though the service provider is no longer eligible to receive or claim the government-subsidy for providing connectivity services to the subscriber.

By way of example, if the subscriber has not used the connectivity service over a continuous period of time (e.g., at least a month), then the service provider may be required to de-enroll the subscriber from the program (e.g., by performing a de-enroll transaction in NLAD, specifying the Transaction Type as “deEnrollNonUsage”) after notifying the subscriber of prospective de-enrollment and following an ensuing cure period (e.g., 15 days) during which the subscriber's non-use is not cured. In some cases, in attempting to notify the subscriber (and, e.g., confirming whether the subscriber wishes to cure the non-use and remain enrolled and, if so, assisting in curing the non-use), the service provider may be unable to successfully contact the subscriber and/or the subscriber may be non-responsive to the notification, possibly due to the subscriber receiving but not responding to the notification, or the subscriber not receiving the notification based on the service provider having inaccurate and/or superseded contact information (e.g., phone number(s) for voice calls and/or text messages, email address(es), US Postal Service address(es)).

Similarly, the subscriber may be required to recertify NV eligibility periodically (e.g., annually), and will become de-enrolled from NLAD if the subscriber fails to successfully recertify. In some cases, failed NV recertification may occur not because the subscriber is no longer eligible but, for example, because the subscriber (i) is non-responsive to NV recertification requests/notifications sent to the subscriber by the FCC (or USAC), possibly due to superseded or inaccurate contact information, or (ii) is responsive to NV recertification requests/notifications but does not adequately and/or accurately provide the required recertification information. Upon the service provider ascertaining (e.g., based on NLAD reports) that the subscriber is de-enrolled (and possibly also ascertaining, e.g., based on querying the NV, that the de-enrollment is based on NV disqualification), the service provider may wish to contact the subscriber to confirm the basis for de-enrollment and, if appropriate according to the subscriber's response, to assist the subscriber in re-enrolling in the program (e.g., performing both the NV certification/re-certification and NLAD enrollment). But, similar to the situation describe for non-use de-enrollment, the service provider may be unable to successfully contact the subscriber and/or the subscriber may be non-responsive to the notification. In such de-enrollment situations, for example, the service provider may be reluctant to (and may elect not to) discontinue service without obtaining the subscriber's confirmation that the subscriber is no longer eligible and/or interested in receiving the service, particularly considering the potential impact that not having connectivity service (e.g., high-speed internet access) may have on the subscriber.

Another illustrative circumstance that may result in the ACP subscriber no longer being enrolled to receive the subsidized connectivity service through the given ACP service provider occurs when the subscriber, though remaining enrolled in the ACP (i.e., properly enrolled in NLAD as an ACP subscriber/consumer), is transferred to a different ACP service provider (e.g., an ACP subscriber may switch providers once per calendar month, if desired). To effect such a so-called transfer-out from the given (prior) service provider (the “transfer-out” provider) to a new service provider (the “transfer-in provider”), after obtaining the subscriber's informed consent, the new (transfer-in) provider performs a so-called transfer transaction in NLAD (e.g., updating the “SAC” information, and specifying the Transaction Type as “transfer”). Upon the (prior) given service provider ascertaining (e.g., based on NLAD reports) that the subscriber has transferred-out, although the transferred-out subscriber presumably has connectivity service with a new provider, the given service provider may wish to contact the transferred-out subscriber to, for example, confirm whether the subscriber actually intended (consented) to switch providers (e.g., to help prevent fraudulent transfers), and, if so, to inquire as to the subscriber's reason for transfer (e.g., to provide improved and/or more competitive services, depending on the subscriber's reason(s)). But, similar to the de-enrollment situations described above, the service provider may be unable to successfully contact the (former) subscriber and/or the subscriber may be non-responsive to the notification.

Accordingly, to facilitate subscribers in a subsidized connectivity service program maintaining and/or re-enrolling in their subsidized connectivity service and/or receiving improved and/or additional services and assistance from providers of the subsidized connectivity service, while also preferably to facilitate identifying and preventing fraudulent activities by subsidized-connectivity-service providers, there is a need for systems and methods that provide a technical solution enabling a service provider of a subsidized-connectivity service to reliably communicate with its subscriber(s) (e.g., its current de-enrolled subscribers and/or its transferred-out subscribers) without relying on phone, text, email, or other mechanisms dependent on subscriber contact information.

### SUMMARY OF SOME EMBODIMENTS

Some embodiments according to the present disclosure relate to methods, systems, and devices for a provider of subsidized connectivity services (e.g., mobile broadband and/or fixed-line broadband) under a subsidized connectivity program to provide a code module to be stored on a non-transitory computer-readable medium of a device to be used by a user to which the provider provides subsidized-connectivity service to under the program (e.g., based on the user being enrolled in the program by the provider, or the user transferring-in to the provider from another provider), wherein the device comprises at least one processor operable in executing the code module to cause at least the following: (i) monitoring of an enrollment status of the user, (ii) based on the monitored enrollment status, selectively prompting the user for a responsive input; and (iii) based on the responsive input and the monitored enrollment status, selectively invoking a change in the enrollment status of the user.

It will be appreciated by those skilled in the art that the foregoing brief description and the following description with respect to the drawings are illustrative and explanatory of some embodiments of the present invention, and are neither representative nor inclusive of all subject matter and embodiments within the scope of the present invention, nor intended to be restrictive or characterizing of the present invention or limiting of the advantages which can be achieved by embodiments of the present invention, nor intended to require that the present invention necessarily provide one or more of the advantages described herein with respect to some embodiments. Thus, the accompanying drawings, referred to herein and constituting a part hereof, illustrate some embodiments of the invention, and, together with the detailed description, serve to explain principles of some embodiments of the invention.

### BRIEF DESCRIPTION OF THE DRAWINGS

Aspects, features, and advantages of some embodiments of the invention, both as to structure and operation, will be understood and will become more readily apparent in view of the following description of non-limiting and non-exclusive embodiments in conjunction with the accompanying drawings, in which like reference numerals designate the same or similar parts throughout the various figures, and wherein:

FIG. 1 depicts a simplified block-type diagram of an illustrative network-based system 100 that may be implemented, in accordance with some embodiments;

FIG. 2 depicts a high-level block diagram of components included in an illustrative consumer device, in accordance with some embodiments;

FIG. 3 depicts a high-level block diagram of components included in another illustrative consumer device, in accordance with some embodiments; and

FIGS. 4A-4E depict a high-level, illustrative flowchart showing steps/actions performed by an code module running on a user device, in accordance with some embodiments.

### DETAILED DESCRIPTION OF SOME EMBODIMENTS

Throughout the description and claims, the following terms take at least the meanings explicitly associated herein, unless the context dictates otherwise. The meanings identified below do not necessarily limit the terms, but merely provide illustrative examples for the terms.

The phrase “an embodiment” as used herein does not necessarily refer to the same embodiment, though it may. In addition, the meaning of “a,” “an,” and “the” include plural references; thus, for example, “an embodiment” is not limited to a single embodiment but refers to one or more embodiments. Similarly, the phrase “one embodiment” does not necessarily refer to the same embodiment and is not limited to a single embodiment. As used herein, the term “or” is an inclusive “or” operator, and is equivalent to the term “and/or,” unless the context clearly dictates otherwise. And, more specifically, the term “and/or” between multiple recited elements is understood as encompassing each combination of at least one element. For instance, “A and/or B” embraces each of A alone, B alone, and both A and B. Likewise, “A, B, and/or C” embraces each of seven combinations comprising at least one of A, B, and C. The term “based on” is not exclusive and allows for being based on additional factors not described, unless the context clearly dictates otherwise.

In addition, as used herein, “automatically” generally refers to occurring, or being capable of occurring, without requiring being invoked or initiated by and/or in response to a human action, unless the context clearly dictates otherwise. As used herein, a “subscriber” includes a household and/or individual that is enrolled in a subsidized program (e.g., for ACP, enrolled in NLAD), or that has been enrolled in but designated as de-enrolled from the subsidized program, unless the context clearly dictates otherwise. As used herein, a “consumer” includes a household and/or individual that either (i) is a subscriber, or (ii) has not been enrolled in, but intends to enroll in, the subsidized program, unless the context clearly dictates otherwise.

Some embodiments according to the present disclosure relate to methods, systems, and devices for a provider of subsidized connectivity services (e.g., mobile broadband and/or fixed-line broadband) under a subsidized connectivity program to provide a code module to be stored on a non-transitory computer-readable medium of a device to be used by a user to which the provider provides subsidized-connectivity service to under the program (e.g., based on the user being enrolled in the program by the provider, or the user transferring-in to the provider from another provider), wherein the device comprises at least one processor operable in executing the code module to cause at least the following: (i) monitoring of an enrollment status of the user, (ii) based on the monitored enrollment status, selectively prompting the user for a responsive input; and (iii) based on the responsive input and the monitored enrollment status, selectively invoking a change in the enrollment status of the user.

In some embodiments, the monitoring indicates that the user has been transferred to a different service provider of the subsidized-connectivity service, the prompting requests that the user confirm whether the user intended (e.g., consented to) the transfer and/or whether the user wishes to transfer back to the provider, and selectively invoking a change in the enrollment status comprises effecting a transfer transaction causing the user to be enrolled in the program as a user receiving the subsidized-connectivity service from the provider.

In some alternative or additional embodiments, the monitoring indicates that the user has been de-enrolled from the subsidized-connectivity service, the prompting requests that the user confirm whether the user wishes to re-enroll in the program with the provider as the user's service provider, and selectively invoking a change in the enrollment status comprises invoking re-enrollment of the user, including prompting the user to provide any additional information that may be needed to effect re-enrollment (e.g., which, for example, if recertification of eligibility/qualification for the program is needed, may include updated personal identifying information, or proof of current qualification (e.g., active Medicaid benefits).

As will be further understood in view of the ensuing disclosure, the program may be a government subsidy program for providing at least free and/or discounted connectivity services to a qualified user, such as, for example, ACP, Lifeline or similar telecommunications subsidy programs. As such, for example, enrollment (and re-enrollment) of a user in the subsidy program (through enrollment in the NLAD) may be contingent on a user first being confirmed as qualified (eligible) for the program through the NV.

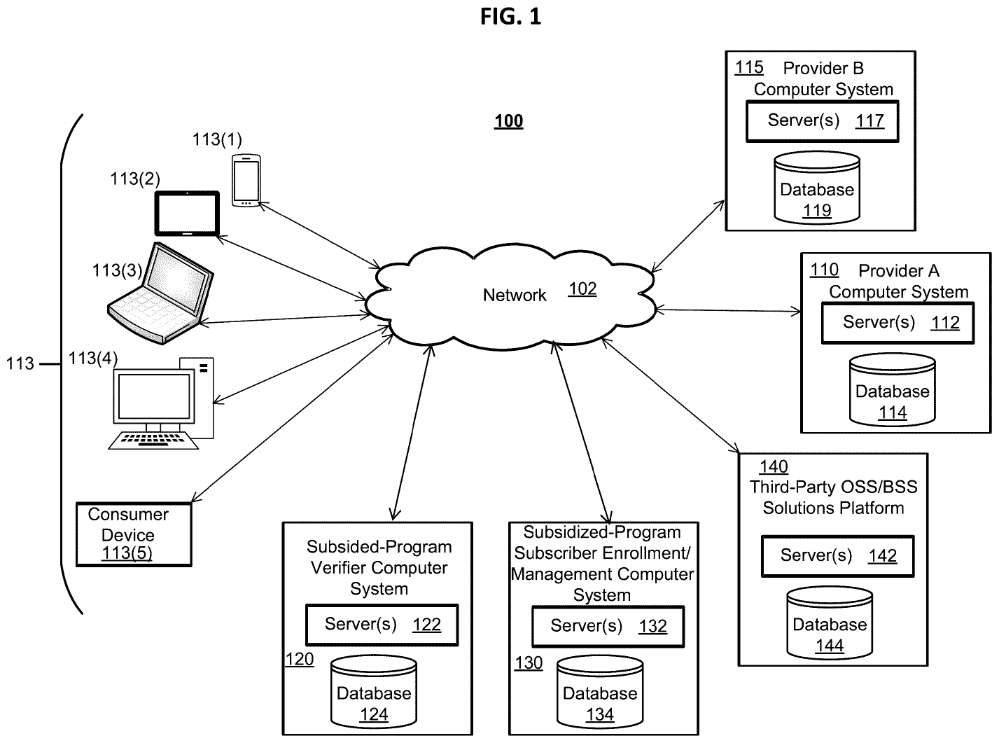

FIG. 1 depicts a simplified block-type diagram of an illustrative network-based system 100 that may be implemented for enrolling consumers in a program for receiving subsidized connectivity services, such as broadband connectivity (e.g., mobile broadband and/or fixed-line broadband for high-speed internet access) and/or cellular connectivity, and for managing the consumers enrolled in the subsidized-connectivity program, including enabling a program-participating service provider to re-enroll with it (i) its subscribers that have been de-enrolled from the program and/or (ii) subscribers that have not been de-enrolled from the program and have been transferred from it to a different program-participating service provider, in accordance with some embodiments of the present disclosure.

As shown, illustrative network-based system 100 comprises network 102 communicably coupled with subsidized-program verifier computer system 120, subsidized-program subscriber enrollment/management computer system 130, Third-Party OSS/BSS Solutions Platform 140, Provider A Computer System 110, Provider B Computer System 115, and Consumer devices 113 (which may comprise, as depicted by way of example, a mobile phone 113(1), tablet 113(2), laptop computer 113(3), personal computer 113(4), and/or any such or other device 113(5) that may be used by a consumer to obtain subsidized connectivity service, in accordance with some embodiments according to the present disclosure. It will be understood in view of the ensuing disclosure that for clarity the illustrative network-based system 100 represents an illustrative configuration that may be implemented in accordance with ACP, employing computer system 120 as the NV for confirming consumer eligibility, and employing computer system 130 as NLAD for enrolling consumers as ACP subscribers associated with a given ACP service provider.

Network 102 generally comprises any combination of one or more public and/or private wired and/or wireless networks, including the Internet, a cellular network, an intranet, an extranet, a wide-area network (WAN), a local-area network LAN, or any other network configuration as well as any associated communication protocols. More specifically, the network 102 may comprise the Internet and any other wired and/or wireless network(s) that provide a network configuration to enable any of the communications (e.g., transfer of data and commands) that may be required based on embodiments in accordance with the present disclosure, including a services provider selectively re-enrolling transferred-out and/or de-enrolled subscribers to receive subsidized connectivity services (e.g., broadband service) from it.

By way of illustration, each of devices 113 may be configured for subsidized Internet access via one or more wireless and/or wired networks, and in such a case network 102 schematically depicts not only the Internet, but also any network (e.g., cellular, premises-based WiFi, and/or Ethernet-based LAN, etc.) through which the given device 113 accesses the Internet. Similarly, as further described hereinbelow, in some embodiments, a given one of devices 113 may be associated with a given subscriber enrolled to obtain subsidized connectivity services under the program through a Provider A (which controls operation of Provider A Computer System 110), wherein the given one of devices 113 may be configured to poll—and communicate other messages with—Third-Party OSS/BSS Solutions Platform 140 to monitor the ACP enrollment status of the given subscriber and to selectively effect a change in the enrollment status of the given subscriber (e.g., re-enrollment with the provider if the monitored ACP status indicates that the given subscriber has been de-enrolled or transferred-out). As such, network 102 comprises any networks required for such polling and other communications between a device 113 and Third-Party OSS/BSS Solutions Platform 140.

Subsidized-program verifier computer system 120 comprising server(s) 122 and/or database 124 is configured to determine eligibility of a consumer in a subsidy program, particularly, a government program for free or subsidized telecommunications devices and/or services, including broadband connectivity, in accordance with some embodiments. For example, computer system 120 may comprise a National Verifier (NV) or equivalent state-specific portal for determining eligibility of an applicant in a government subsidy program such as ACP. A consumer may apply for eligibility either directly through an NV consumer portal embodied in computer system 120, or with the assistance of a service provider who assists the consumer in providing their information to the NV. A consumer found eligible is entered into database 124, which may be accessed by service providers (e.g., via an automated database connection, such as provided by an application programming interface (API)), such as a Provider A and a Provider B, associated respectively with computer systems 110 and 115. It will be understood in view of the present disclosure that service providers (e.g., Provider A and Provider B) according to various embodiments may include any combination of broadband connectivity providers that may provide subsidized connectivity services (e.g., high-speed Internet), including for example, fixed (wired and/or wireless) broadband providers and mobile (wireless) broadband providers, such as cable and/or fiber Internet Service Providers (ISPs), mobile network operators (MNOs), mobile virtual network operators (MVNOs), and WiFi providers.

Subsidized-program subscriber enrollment management computer system 130 comprising server(s) 132 and/or database 134 is configured to enable service providers to enroll subsidy-program-eligible consumers (e.g., consumers qualified through subsidized-program verifier computer system 120, and accordingly stored in database 124) in a subsidy program, particularly, a government program for free or subsidized telecommunications devices and/or services, including broadband connectivity, in accordance with some embodiments. As may be understood in view of the foregoing and ensuing disclosure, in some embodiments, such as wherein the subsidy program is a governmental subsidy program such as ACP, computer system 130 may comprise NLAD or equivalent state-specific portal for enrolling consumers in the government subsidy program.

More specifically, for example, a service provider (e.g., Provider A) may enroll a consumer in the subsidy program as its subscriber by submitting a transaction (e.g., by uploading a file or batch file, or by API request) with respect to the consumer/subscriber in database 134, wherein information provided by the service provider for enrollment (e.g., via subscriber-file upload, or via an API) may include certain subscriber and related information identifying the subscriber (e.g., including personal identifying information (PII) as it appears in the database 124), along with service-provider identifying information (e.g., the Study Area Code (SAC), or SAC number in NLAD), and information identifying the type of transaction (e.g., the “Transaction Type” information in the NLAD) as an “enroll” transaction. Before successfully enrolling the subscriber presented for enrollment by the service provider, subsidized-program subscriber enrollment management computer system 130 may separately confirm, for example, that the subscriber is eligible/qualified (i.e. the subscriber is in database 124), that the subscriber information (e.g., PII) received for enrollment matches the information in database 124, and that the subscriber does not already exist in database 134 (e.g., that there is no duplicate subscriber error).

Service providers may be required to update database 134 upon identifying a change or event relating to information stored in database 134 with respect to subscribers. For instance, information stored in database 134 with respect to subscribers (e.g., information stored as subscriber records of database 134) may include (among other things) the subscriber's name and contact information, information identifying the service provider associated with the subscriber (i.e., the service provider providing connectivity services to the subscriber and entitled to claim the subsidy benefit on behalf of the subscriber), as well as information identifying the latest action/transaction that a service provider performed with respect to a subscriber entered in database 134 (e.g., which may be referred to as “Transaction Type” information).

Thus, for example, a service provider may be required to update database 134 (e.g., by file upload or via API request) upon receiving from the subscriber a change to the subscriber's contact information (e.g., address change). To do so, the service provider may perform a transaction identified as an “update” Transaction Type and including the changed/new contact information.

Also, for example, if a subscriber transfers its subsidy program benefit to a different service provider from which the subscriber wishes to receive connectivity services, then the new service provider may be required to update the subscriber's record in database 134. To do so, the new service provider may perform a transaction identified as a “transfer” Transaction Type and including the information identifying the new service provider (e.g., the Study Area Code (SAC), or SAC number in the NLAD database). (As indicated hereinabove, the Transaction Type may be identified as “enroll” when the subscriber is initially enrolled in the program by a service provider.)

As yet a further example, some circumstances may require a service provider to perform a transaction to de-enroll a subscriber from the program (such that the subscriber will no longer receive the subsidy program benefit and, therefore, service provider is no longer eligible to receive or claim the subsidy for providing connectivity services to the subscriber). For instance, as described in the background section above, a service provider may be required to de-enroll a subscriber who has not used the connectivity service over a continuous period of time (e.g., at least a month), after notifying the subscriber of prospective de-enrollment and following an ensuing cure period (e.g., 15 days) during which the subscriber's non-use is not cured. To effect de-enrollment, the service provider may submit a de-enroll transaction to system 130 (e.g., to database 134 via file upload or API request), specifying the Transaction Type as “deEnrollNonUsage” (e.g., different de-enroll transaction types may be designated corresponding to other reasons for de-enrollment).

Accordingly, it may be understood that service providers may effectively ensure that database 134 stores up-to-date subscriber records, which may include recent Transaction Type information, PII, and other required, conditional, or optional information (such as birth date, effective transaction date, subscriber device information, etc.). It may also be understood that the foregoing Transaction Types are merely illustrative; alternative and/or additional transaction types may be implemented in various embodiments.

In accordance with some embodiments, third party OSS/BSS Solutions Platform 140 (“OSS/BSS platform 140” for ease of reference) is a third-party operations support system (OSS) and business support system (BSS) platform (e.g., including Customer Relationship Management (CRM)) that may be subscribed to by one or more service providers (e.g., Provider A and Provider B). More specifically, OSS/BSS platform 140 maintains and operates—and provides its subscribed customer/client service providers access to—computing/information-technology (IT) resources and tools, such as customer portals, real-time customer profiles, iOS and Android apps, network status and diagnostic tools, billing solutions, and other features that a provider may require (or desire) for managing its subscribers and connectivity services. For instance, solutions platform 140 may be implemented as a cloud-based SaaS (Software-as-a-Solution) platform, wherein OSS/BSS solutions for its subscribed service providers are separately instantiated (e.g., multi-instance architecture), and may be accessed by the subscribed service providers (e.g., Provider A and Provider B respectively associated with Provider A Computer System 110 and Provider B Computer System 115) and customer devices 113 via network 102 and may provide for API integration. As may be understood by those skilled in the art in view of the present disclosure, in some embodiments, OSS/BSS Solutions Platform 140 may be provided by Telgoo5 or Unavo.

In view of the foregoing, it may be understood that with respect to the hereinabove descriptions of, for example, service providers communicating (including transacting) with computer systems 120 and 130 (e.g., including communications/transactions with databases 124 and 134, such as with respect to enrolling, transferring, and/or de-enrolling subscribers), such communications/transactions would be performed by OSS/BSS platform 140 if the provider is a subscriber to and user of OSS/BSS platform 140 for its CRM and related operations. Likewise, various communications (including transactions) as may be described herein between consumer devices 113 and service providers would be between the consumer devices 113 and OSSB SS platform 140 for providers subscribed to and using OSS/BSS platform 140 for its CRM and related operations.

As understood by those skilled in the art, for each of its subscribed service providers, OSS/BSS platform 140 may maintain (and store in database 144) a respective subsidy-program subscriber account list comprising certain information/data for each current subsidy-program subscriber of the service provider. By way of non-limiting example, this information/data contained in the subscriber account list for a given subsidy-program subscriber of the service provider may include personally identifiable information (PII) such as the subscriber's name, contact information (e.g., residence address, email address, phone number, etc.), last four social security number digits (SSN4), as well as information about the device(s) that the subscriber/consumer may use with the subsidized connectivity service, such as device type, and unique identification information, such as mobile device number (MDN), IMEI (International Mobile Equipment Identity) or MED (Mobile Equipment Identifier), SIM card Integrated Circuit Card ID (ICCID), WiFi adapter MAC address, wired (e.g., Ethernet) adapter MAC address, and/or any other unique identifier for the device(s). It may be understood that some of this information may be obtained by the service provider (e.g., via OSS/BSS platform 140) upon initially enrolling a subscriber in the government-subsidized program or upon transferring-in a subscriber from another service provider. It thus may be understood that while the subsidy-program subscriber account list maintained by and stored in OSS/BSS platform 140 may include information contained in the enrolled subscriber records stored in database 134, the subscriber account list database schema is not necessarily identical to—and is typically different from—the schema of the enrolled subscriber database 134.

In this regard, as further described below, in some embodiments the subsidy-program subscriber account list maintained by and stored in OSS/BSS platform 140 may also include an Enrollment Status Indicator (hereinafter, “ESI” for ease of reference) for each current subsidy-program subscriber of a given provider subscribed to and using OSS/BSS platform 140. The ESI may be generated and regularly updated by OSS/BSS platform 140 based on subscriber records in database 134 (e.g., NLAD, in some embodiments). In this regard, in some embodiments, OSS/BSS platform 140 may regularly access subscriber data from database 134 (e.g., NLAD), such as via API requests and/or file downloads. In accordance with various implementations, the timing of such regular subscriber data access may occur in various ways, including but not limited to the following illustrative ways: (i) daily, possibly scheduled for a particular time or for within a time window each day; (ii) a plurality of times each day, such as at predetermined times or intervals; (iii) upon the occurrence of certain events and/or the satisfaction of certain conditions.

More specifically, in some embodiments, OSS/BSS platform 140 may be configured to generate and regularly update an ESI for each subsidy-program subscriber (e.g., each ACP subscriber, in some embodiments) of a given provider (e.g., Provider A) that is a user of OSS/BSS platform 140. In some embodiments, for example, the ESI may be based on data such as the Transaction Type, SAC, and other subscriber record data described hereinabove, that OSS/BSS platform 140 may regularly access. In some embodiments, for any given subscriber, ESI may be based on temporal changes in the subsidy-program subscriber's record data (e.g., between successive pulls of the subscriber's records by OSS/BSS platform 140). Alternatively or additionally, ESI may be based on comparisons between a subsidy-program subscriber's record accessed from database 134 and the provider's subsidy-program subscriber account list maintained by and stored in OSS/BSS platform 140. In some embodiments, consumer eligibility data stored in database 124 also may be accessed by OSS/BSS platform 140 to facilitate generating and updating an ESI for at least some subsidy-program subscribers (e.g., selectively accessed based on certain conditions where eligibility information may help resolve ambiguity or uncertainty in determining ESI).

By way of non-limiting example, in some embodiments wherein the subsidy program is ACP, and database 134 is implemented as NLAD (and database 124 is implemented as the NV), ESIs generated by and stored in the OSS/BSS platform 140 (i.e., stored in database 144 in a subsidy-program subscriber account list) for subsidy-program subscribers of a given subsidy-program services provider (e.g., Provider A) based on, for example, subscriber record data obtained from NLAD may be implemented as follows:

(i) ESI is designated as “Transfer-out” if the OSS/BSS platform 140 determines that the subscriber has been transferred from the subscribed given service provider (e.g., Provider A) to another provider. It may be understood that subscriber records pulled from NLAD (database 134) by OSS/BSS platform 140 for a particular SAC (corresponding to a particular provider; e.g., Provider A) will not include subscriber records for subscribers that have been transferred-out to (transferred-in by) another provider since the time of the last such NLAD records pull. In other words, the transfer-out subscriber will not be found on the NLAD active subscriber list. Accordingly, OSS/BS S platform 140 may identify subscribers of a given provider (e.g., Provider A) that have been transferred-out based on identifying subscribers in the provider's current subsidy-program subscriber list (stored in database 144) that are missing from the NLAD active subscriber list pulled with respect to the particular provider (i.e., according to the provider's SAC). It may be understood that in various embodiments, OSS/BSS platform 140 may then further pull and review the NLAD transaction records (and possibly also NV records) for such identified missing subscribers to further confirm that the subscriber did, in fact, transfer-out. OSS/BSS platform 140 may then update the provider's current subsidy-program subscriber list (stored in database 144) by designating the ESI for such identified (and, e.g., confirmed) subscribers as “Transfer-out.”

(ii) ESI is designated as “Enrolled” in the provider's current subsidy-program subscriber list (stored in database 144) for each of the subscribers who are found on the NLAD active subscriber list. It should be noted that an enrolled customer's last transaction can be “enroll” or “transfer in.” Accordingly, database 144 should already have the customer ESI designated as “Enrolled” prior to pulling the active subscriber list from NLAD, since the transaction with NLAD was previously initiated by system 140.

(iii) ESI is designated as “Deenrolled” if the OSS/BSS platform 140 determines that the subscriber has been Deenrolled from the subscribed given service provider (e.g., Provider A) to another provider. It may be understood that subscriber records pulled from NLAD (database 134) by OSS/BSS platform 140 for a particular SAC (corresponding to a particular provider; e.g., Provider A) will not include subscriber records for subscribers that have been deenrolled since the time of the last such NLAD records pull. In other words, the transfer-out subscriber will not be found on the NLAD active subscriber list. Accordingly, OSS/BSS platform 140 may identify subscribers of a given provider (e.g., Provider A) that have been deenrolled based on identifying subscribers in the provider's current subsidy-program subscriber list (stored in database 144) that are missing from the NLAD active subscriber list pulled with respect to the particular provider (i.e., according to the provider's SAC). It may be understood that in various embodiments, OSS/BSS platform 140 may then further pull and review the NLAD transaction records (and possibly also NV records) for such identified missing subscribers to further confirm that the subscriber did, in fact, get deenrolled. OSS/BSS platform 140 may then update the provider's current subsidy-program subscriber list (stored in database 144) by designating the ESI for such identified (and, e.g., confirmed) subscribers as “Deenrolled.” It should be noted that database 144 may already have the customer status listed as “Deenrolled” from the time that the transaction occurred, because the transaction was initiated via system 140.

While the foregoing description expressly describes illustrative embodiments wherein a subsidy-program services provider (e.g., Provider A) subscribes to and uses third-party OSS/BSS solutions platform 140 to carry out, e.g., BSS/CRM functionality with respect to its subscribers, and to generate and regularly update (and store) a subscriber ESI based on regularly accessing subscriber information stored in NLAD, the use of a third-party OSS/BSS solutions platform by a service provider is not required for practicing embodiments according to the present disclosure.

More specifically, as represented by FIG. 1, a Provider A and a Provider B—each of which provides, for example, subsidized broadband connectivity services to respective customers/subscribers (such as subscribers using consumer devices 113) —may have associated respective computer systems 110 and 115, each of which may be an on-premises system maintained and operated by the respective provider. In various embodiments wherein Provider A (Provider B) subscribes to and uses third-party OSS/BSS solutions platform 140, such as described above (and as also further described hereinbelow by way of example), Provider A may, for example, use computer system 110 (115), comprising server(s) 112 (117) and database 114 (119), to access system 140 (e.g., via API integration) and/or store/retain and manage certain of the provider's subscriber/customer information.

In various alternative embodiments, however, computer system 110 (115) may be configured to implement and supplant all (or at least some of) the 3^{rd}-party OSS/BSS system 140 functionality for Provider A (B). As such, it will be understood that all embodiments discussed herein with respect to functionality provided by 3^{rd}-party OSS/BSS system 140 for any given provider may alternatively be implemented by the given provider's computer/IT system such as the computer system 110 (115) of Provider A (B). While for conciseness and clarity of exposition, such alternative embodiments are not explicitly discussed, they will be understood by those skilled in the art as being fully disclosed by the present disclosure.

It may also be understood that, while only two providers are explicitly represented in FIG. 1 (e.g., for simplicity and clarity of exposition), network-based system 100 may comprise many additional service providers that may provide subsidized connectivity services for consumers, such as consumers associated with devices 113. And, likewise, it will be understood that network-based system 100, in practice, may include numerous additional consumer devices (and associated consumers) and other third-party OSS/BSS solutions platforms (and associated vendors) not depicted in FIG. 1.

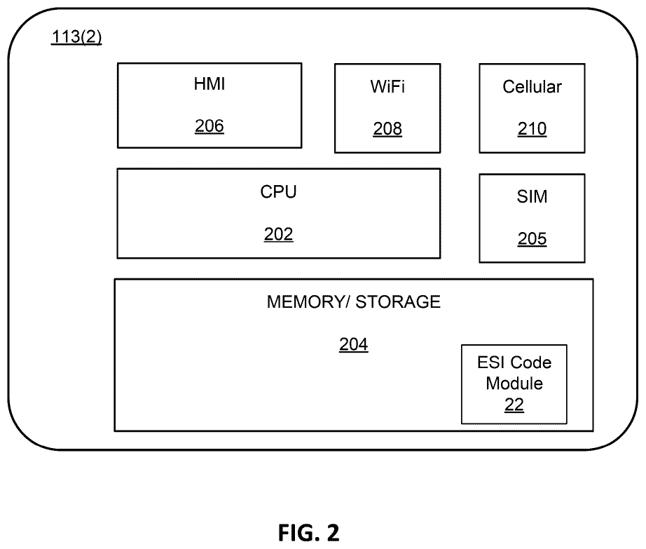

FIG. 2 depicts a high-level block diagram of components included in an illustrative consumer device 113, particularly a tablet 113(2), in accordance with some embodiments. As shown, tablet 113(2) includes a CPU module 202 that comprises at least one processor core (e.g., CPU module 202 may be a multi-core CPU), and, as known to those skilled in the art, is operable to access (e.g., read from and/or write to) code and data stored on at least one computer-readable medium, such as included in memory/storage module 204, and to selectively execute such code, including application and operating system execution, and handling other data processing and communications-related (e.g., I/O) tasks, and overall system management.

Memory/Storage module 204 may comprise, for example, Random Access Memory (RAM) (e.g., for process execution), as well as a non-volatile memory, such as NOR flash memory (e.g., which may store control code), and solid state storage, such as NAND flash-based storage, which may store the operating system, user data, and applications. As may be appreciated, RAM and flash memory(ies) may be implemented as separate integrated circuit chips coupled to a common bus with CPU module 202, and CPU module 202 may in some embodiments include on-chip RAM (e.g., cache) and, possibly, on-chip flash memory in some implementations. As shown, an ESI code module 22, further described hereinbelow, is stored in Memory/Storage module 204, in accordance with subscriber status monitoring and selective re-enrollment (or enrollment) in accordance with some embodiments of the present disclosure.

Tablet 113(2) also comprises a Human-Machine Interface (HMI) 206, which may comprise a touch-sensitive display (e.g., which may also provide for a virtual keyboard interface in some applications), as well as audio interfaces (e.g., microphone and speaker interfaces).

As depicted, tablet 113(2) also includes wireless communications interfaces, particularly a cellular communication module 210 and a WiFi communications module 208. Cellular communication module 210 may support multiple frequency bands and protocols/standards, such as 2G, 3G, 4G, and 5G technologies, thus enabling voice and data communications, including, for example text messaging (e.g., SMS, MMS), and mobile data services (e.g., mobile broadband), such as subsidized connectivity services provided by service providers (e.g., Providers A and B, discussed above) under a subsidized connectivity program, in accordance with embodiments of the present disclosure.

Wi-Fi communications module 208 supports Wi-Fi standards, such as 802.11a/b/g/n/ac/ax (and, e.g., may comprise dual-band capabilities to ensure reliable and high-speed wireless connections in various Wi-Fi environments), supporting wireless broadband data services such as various subsidized connectivity services (e.g., WiFi hotspot connectivity) by some service providers (e.g., WiFi providers) under a subsidized connectivity program, in accordance with embodiments of the present disclosure. As known by those skilled in the art, Wi-Fi communications module has a MAC address that uniquely identifies it (and thus device 113(2)), and which in various implementations may be (i) ascertained programmatically on device 113(2) (e.g., by an app or native or add-on code, such as ESI code module 22, in some implementations) and/or, for example, by another device (e.g., on the same local network) communicating with device 113(2) via WiFi communication module 208, and/or (ii) provided by the user of the device to the service provider and/or to the ESI code module 22 (e.g., upon enrollment in the subsidy-based program and/or upon downloading and activating/opening ESI code module 22), and/or (iii) stored by a service provider (e.g., in database 144 or 114 and/or in the tablet as data for ESI code module 22) that supplies (e.g., sells or provides at no cost) the tablet to the user/subscriber.

Consumer device tablet 113(2) also includes a SIM module 205 (which may be implemented as a SIM card or embedded SIM (eSIM)) that stores its unique Integrated Circuit Card Identification Number (ICCID; also referred to herein as the “SIM card number” or “SIM module number”), the unique Mobile Directory Number (MDN), and unique International Mobile Equipment Identity (IMEI), as well various subscriber-specific data, enabling cellular network authentication and personalization.

As understood by those skilled in the art in view of the present disclosure, mobile phone 113(1) may comprise essentially the same components and functionality described hereinabove for tablet 113(2). As may be appreciated, however, in some implementations, a tablet such as tablet 113(2) may not be configured for cellular communications, and thus may include neither SIM module 205 nor cellular communications module 210, which would be included in a mobile phone.

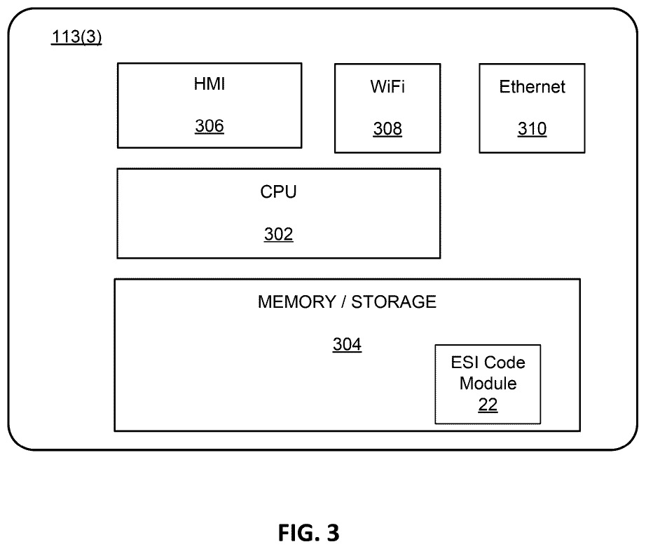

FIG. 3 depicts a high-level block diagram of components included in an illustrative consumer device 113, particularly a laptop computer 113(3), in accordance with some embodiments. As shown, laptop computer 113(3) includes a CPU module 302, Memory/Storage module 304 (storing ESI Code Module 22), and WiFi communication module 308, which are essentially equivalent modules to the corresponding modules described hereinabove with respect to tablet 113(2), and thus are not further described for conciseness. Human-Machine Interface (HMI) 306 may comprise a touch-sensitive screen, and may further comprise a manual keyboard, touchpad, and pointing device such as a mouse. Memory/Storage module 304 may comprise a hard disk drive (HDD) in addition to or as an alternative to a flash-based storage device (solid state drive (SSD)).

As shown, laptop computer 113(3) comprises an Ethernet communication module 310, which may support Ethernet standards such as 10/100/1000 Mbps (Gigabit Ethernet) to provide communication with, for example, local area networks (LANs) and broadband modems, enabling high-speed wired connectivity supporting wireless broadband data services such as various subsidized connectivity services provided by some service providers under a subsidized connectivity program, in accordance with embodiments of the present disclosure. As known by those skilled in the art, Ethernet communications module has a MAC address that uniquely identifies it (and thus device 113(3)), and which in various implementations may be (i) ascertained programmatically on device 113(3) (e.g., by an app or native or add-on code, such as ESI code module 22, in some implementations) and/or, for example, by another device (e.g., on the same local network) communicating with device 113(3) via Ethernet communication module 310, and/or (ii) provided by the user of the device to the service provider and/or to the ESI code module 22 (e.g., upon enrollment in the subsidy-based program and/or upon downloading and activating/opening ESI code module 22), and/or (iii) stored by a service provider (e.g., in database 144 or 114 and/or in the laptop 113(3) as data for ESI code module 22) that supplies (e.g., sells or provides at no cost) the laptop 113(3) to the user/subscriber.

As understood by those skilled in the art in view of the present disclosure, personal computer 113(4) may comprise essentially the same components and functionality described hereinabove for laptop computer 113(3).

It may also be understood in view of the foregoing, that each consumer device 113 used for receiving subsidized connectivity services from service providers in accordance with embodiments according to the present disclosure will be configured to store (and execute) an ESI code module 22 (or an equivalent or corresponding code module) for monitoring the subsidy-program enrollment status of a subscriber/user associated with the consumer device 113, and for selectively effecting re-enrollment of subscriber based on the monitored enrollment status and on information that the ESI code module obtains from the subscriber/user via the HMI of the consumer device 113, as will be further understood in view of the ensuing disclosure.

ESI code module 22 may be installed/stored on a consumer device 113 in any of various ways, such as the following:
a. An ESI code module of/for a given provider (e.g., Provider A) may be installed/pre-installed by a device manufacturer or distributor on a device supplied for the given provider to sell/provide to a subsidized-connectivity-services program consumer/subscriber. As such, the ESI code module is necessarily installed on the device prior to the device being provided (e.g., sold or delivered) by the given provider to a subsidized-connectivity-services program consumer/subscriber. For instance, for Android devices, the code module may be preloaded as an APK (Android Package Kit), an application package format,
b. An ESI code module of a given provider (e.g., Provider A) may be wirelessly pushed to a consumer/subscriber device having a SIM module using OTA (Over-the-Air) Technology.
c. An ESI code module of a given provider (e.g., Provider A) may be delivered/pushed to consumer/subscriber device using MDM (Mobile Device Management) for consumer/subscriber devices having an MDM profile/agent of the provider.
d. An ESI code module may be downloaded from an app store or other server or repository (e.g., via a link on the provider's website). Such app downloading may be particularly well-suited for consumer/user devices that do not have cellular connectivity. (Upon downloading and opening the ESI code module app, the consumer/user may be requested by the app to provide certain personal identifying information (e.g. name, email address, etc.) and possibly also certain device-unique/identifying information, such as a MAC address. Such information provided by the consumer/user may also be delivered (e.g., by the app) to the provider (e.g., to computer system 110 and/or to OSS/BSS system 140) for storage (e.g., in database 114 and/or database 144).

In accordance with some embodiments, with ESI code module 22 stored on a user device (e.g., one of devices 113), the ESI code module may be configured to be executed by the device CPU as a background process/app such that it monitors (e.g., checking at some scheduled interval and/or possibly upon certain events, such a device power-up, or upon an internet browser window and/or certain apps being opened) the customer's/subscriber's Enrollment Status (which may also be referred to herein in connection with ACP implementation as “ACP status”) by pinging/polling OSS/BSS database 144. If the ESI code module receives an ESI message from OSS/BSS database 144 indicating that the customer's/subscriber's enrollment status is “Enrolled,” (i.e., enrolled with the provider; e.g., Provider A), then ESI code module continues monitoring the customer's/subscriber's Enrollment Status (i.e., by polling OSS/BSS database 144 (e.g., via an API request), such as every 12 hours, simply by way of non-limiting example).

In accordance with some embodiments, if an ESI status obtained by ESI code module 22 from OSS/BSS database 144 (e.g., via an API request) is any status other than “Enrolled” (e.g., is Transfer-out or DeEnroll, or possibly other non-Enroll ESI indicators that may be implemented, such as “PendingResolution”), then ESI code module 22 invokes an appropriate re-enrollment process (e.g., depending on whether the ESI status was Transfer-out or DeEnroll), wherein ESI code module 22 may be configured to, e.g., perform at least the following for confirming and effecting re-enrollment, (i) communicate with the consumer via the device HMI to prompt and obtain information from the user (and assist/guide the user) and (ii) communicate with, e.g., OSS/BSS computer system 140 (e.g., database 144) and possibly also with database 124 (e.g., the NV) and database 134 (e.g., the NLAD). In this regard, it may be understood that in various implementations, reenrollment can occur from ESI code module 22 communications to the NV and NLAD via a 3rd party system (e.g., Telgoo or Unavo), or via service provider A's system 110, or with direct communication to NV and NLAD (e.g., ESI code module 22 may be configured with all APIs needed to perform all transactions/requests and other communications with NV and/or NLAD to carry out enrollment/reenrollment as, for example, Telgoo or Unavo or other 3^{rd} party OSS/BSS platform. Once successfully effecting re-enrollment, ESI code module 22 continues monitoring enrollment status (i.e., polling OSS/BSS database 144 for the subscriber's ESI status). (For clarity, it is noted that, as used herein, “polling” may refer to time-driven (e.g., periodic) and/or event-driven queries or pings, unless the context clearly dictates otherwise.)

In accordance with some embodiments, if in response to an ESI status request (e.g., an API request) from ESI code module 22 (e.g., which may be the initial request from ESI code module 22, upon ESI code module 22 being invoked on the device), the information obtained by ESI code module 22 from OSS/BSS database 144 indicates that the customer has no enrollment status (i.e., there is no record of the customer in the OSS/BSS database 144; because, for example, the customer never signed up with the provider (e.g., Provider A) for the subsidy program), then ESI code module 22 is configured to effect an enrollment process. (Note that there may also be no enrollment status for the customer but the customer is still in database 144, in the case that customer information is stored in database 144 upon device purchase.) Such an enrollment process is essentially an initial enrollment of the customer in the subsidy program as a subscriber of Provider A. So, while similar to a re-enrollment process, an initial enrollment process differs at least insofar as ESI code module 22 must further be configured to obtain from the customer certain personal information needed to apply for the subsidized connectivity program, and must also submit that information to the NV for program approval before the customer can be enrolled in NLAD. In addition, upon successful enrollment, the customer's device may require activation for the first time for accessing the subsidized connectivity services.

In accordance with the foregoing, it may be understood that an ESI status request from ESI code module 22 to OSS/BSS database 144 must include information uniquely identifying and/or uniquely associated with the consumer/subscriber and included in the database, so that the database query/request may be performed/effected. In accordance with some embodiments, such identifying information as used and/or obtained by ESI code module 22 may include the following:
a. The customer's MDN (mobile device number; which is unique to the specific customer) and/or IMEI (International Mobile Equipment Identify) and/or the SIM module number (ICCID; Integrated Circuit Card Identifier), each of which the ESI code module 22 can identify on the customers' device.
b. The customer's email or personal information, which may be obtained by ESI code module 22 when, for example, the customer signs-up-to/registers-via the ESI code module 22, such as when the ESI code module 22 is downloaded (and activated) or otherwise invoked/activated on the device.

Additional aspects, features, and advantages of distributed end-user-device enrollment status monitoring, and preferably also end-user-device re-enrollment and enrollment, may be further understood in view of the ensuing description of illustrative processes effected by ESI code module 22 with reference to illustrative flowcharts. For purposes of clarity of exposition, and by way of further illustration, the ensuing description of some embodiments according to the present disclosure is set forth in the context of the subsidized connectivity program being ACP, with database 124 being NV, database 134 being NLAD, system 140 representing Telgoo5, and an ESI code module running on a user device to monitor the ACP enrollment status of a user/consumer with respect to a Provider A. As discussed hereinabove, in various alternative embodiments, Provider A may implement a computer/IT system 110 that performs and supplants all functionality carried out by third-party OSS/BSS platform 140 (at least with respect to ACP enrollment, re-enrollment, and status monitoring), so it will be understood that all steps/actions described herein as being performed by third-party OSS/BSS platform 140 (e.g., Telgoo5 or Unavo) may be instead performed by Provider A's computer system 110, in accordance with various alternative embodiments.

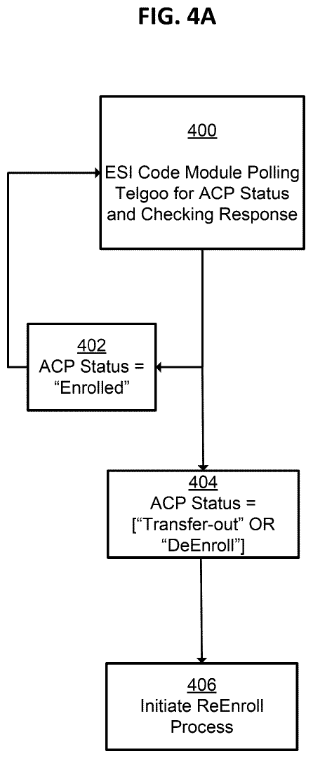

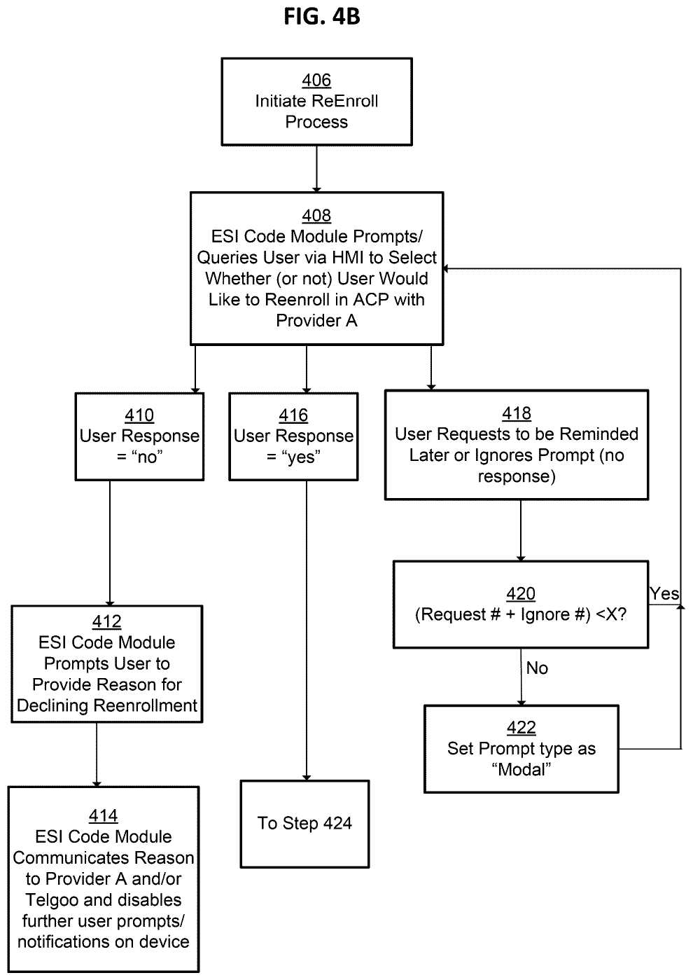

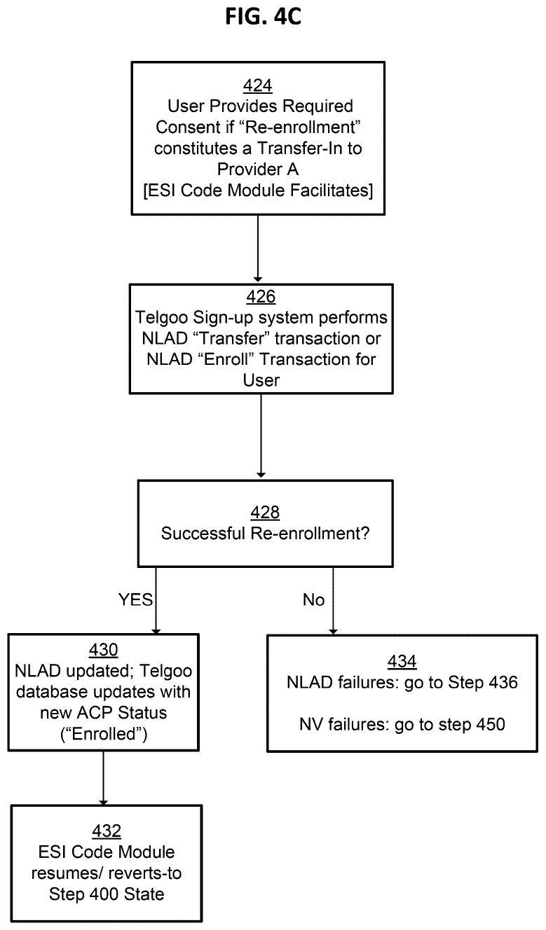

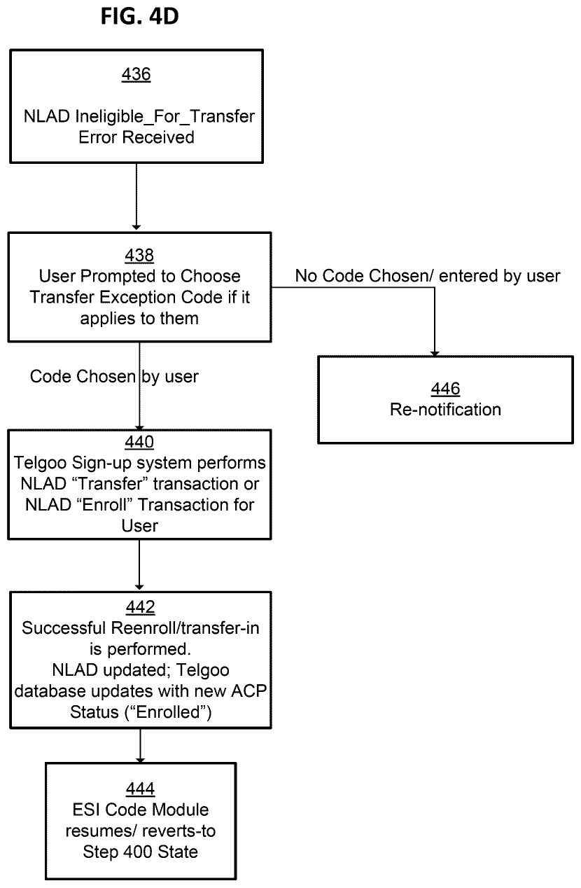

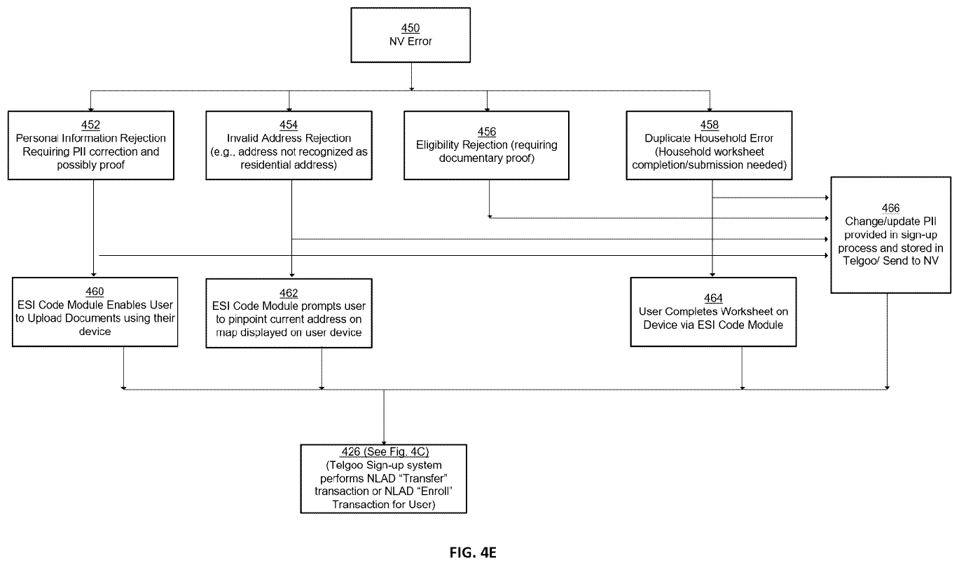

FIGS. 4A-4E depict a high-level, illustrative flowchart showing steps/actions performed by an ESI code module running on a user device to monitor the ACP enrollment status of a user/consumer with respect to a Provider A, and to selectively re-enroll the user/consumer in the ACP as a subscriber of Provider A, in accordance with some embodiments. For clarity of exposition of various features and advantage that may be provided according to various embodiments, it is presumed that the ESI code module is already stored in the memory of and being executed by one or more of the at least one processor of a user device, and that the ESI code module is being used to monitor the ACP enrollment status with respect to Provider A of a user/consumer enrolled in ACP (e.g., in NLAD) by and as a subscriber of Provider A. It is further presumed that the ESI code module has a stored unique identifier (e.g., MDN or personal identifying information) for use in polling Telgoo5 for ACP Status (e.g., corresponding to ESI, as described hereinabove, and having designations of “Enroll,” DeEnroll,” and “Transfer-out”).

More specifically, referring to FIG. 4A, in step 400, ESI code module is in a polling state, wherein the ESI code module periodically (e.g., every “X” minutes and/or every “Y” hours, such as every 45 minutes, or instead every 12 hours) causes the user device in which it is running to communicate via network 102 an ACP Status request (e.g., an API request) to Telgoo, wherein the ACP Status request includes a unique identifier that is recognized by Telgoo, In this polling state, the ESI code module monitors/checks the information it pulls from Telgoo with the ACP Status request.

As indicated by block 402, if the ESI code module identifies the responsive ACP Status provided by Telgoo as “Enrolled,” then ESI code module proceeds with continuing polling Telgoo for the ACP Status.

If, however, the ESI code module identifies the ACP Status provided by Telgoo as either “Transfer-out” or “DeEnroll” (indicated by block 404), then ESI code module proceeds to initiate a re-enroll process (tag 406). As described hereinabove, illustrative conditions that may result in the ACP Status becoming “DeEnroll” included, for example, the customer automatically being removed from ACP because they failed to recertify their qualification/eligibility for ACP (via the NV), or Provider A being required to deenroll the customer in NLAD based on the customer not having used the ACP services for a minimum period of time (e.g., 30 days, with no cure within 15-day notice period).

As shown in FIG. 4B, the re-enroll process continues in step 408, wherein the ESI Code module prompts the user to confirm whether (or not) the user wishes to re-enroll in ACP as a subscriber of Provider A. The user may also be presented with a “Remind Me Later” option.

As shown, if the user declines re-enrollment (step 410), then the ESI Code Module (step 412) prompts the user to provide a reason for declining reenrollment (possibly presenting several options to select from and/or an input field (e.g., and “Other Reason” field) in which the user may input (e.g., type) a reason. Upon receiving the user's input reason, the ESI Code module then (step 414) communicates the reason to Provider A (e.g., to system 110, via network 102) and/or may communicate the reason to Telgoo, which may then store the reason in their database(s) for subsequent CRM-related analytics.

If, however, the user requests to be reminded later of the prompt (i.e., defers responding) or ignores the prompt (step 418), then in step 420—if the sum of the number of user-requested reminders (deferrals) and the number of times the user has ignored the prompt is less than some predetermined number (e.g., 3), then after a delay (not expressly shown in FIG. 4B) ESI Code module again prompts the user in step 418 (permitting the user to again ignore or request a reminder). But if the sum in step 420 reaches the predetermined number (e.g., 3), then ESI Code module may set the prompt (or dialog box) type as a so-called “modal” type, and then again displays the prompt to the user in step 418. If the prompt type is set as modal, the user cannot ignore the message because the operating system prevents the user from performing other actions on the device without first responding to the prompt. It is noted that ESI Code module may disable (and possibly not display) any field in the prompt that may indicate that the user can select a “remind me later” option.

If in response to the prompt in step 408 the user indicates that it wishes to proceed with reenrollment (step 416), then the re-enrollment process proceeds to step 424 (FIG. 4C), wherein the user provides the consent required in the case that the re-enrollment process is a transfer-in to Provider A from another provider. ESI Code Module 22 may facilitate receiving this consent (e.g., oral or written consent) through the HMI of the user device and providing it, for example, to Telgoo 140 and/or Provider A's system 110 for storage (e.g., in databases 144 and/or 114). Telgoo then proceeds (step 426) with performing an appropriate NLAD transaction; namely, e.g., a Transfer transaction type or an Enroll transaction type. A successful NLAD re-enrollment (steps 428 and 430) corresponds to NLAD being updated to reflect the enrollment of the user in the program as a subscriber of Provider A, and results in Telgoo updating the subscriber's ACP status to “Enrolled” in database 144. The ESI Code Module then continues with/resumes its polling state (step 432; step 400). In some embodiments, ESI Code Module 22 may perform the NLAD transaction directly (e.g., without Telgoo), and upon successful re-enrollment would notify Telgoo at the subscriber's changed status. It is noted, however, that to perform the NLAD transaction, ESI Code Module 22 must pull personal information from Telgoo 144 to include in transaction request to NLAD.

If re-enrollment is not successful (step 428) then such unsuccessful re-enrollment may be due to various identified NLAD failures and/or NV failures (step 434), which then may be addressed by various actions in which ESI Code Module 22 again may facilitate interfacing directly with the user to request and obtain relevant information from the user and provide it to NV, NLAD, Telgoo, and/or Provider A's system 110 as may be appropriate or required, including, for example, in assisting the user in providing information to various entities (e.g., NV) via a redirect through the user device to the particular entity's portal. In some implementations and/or for various errors, ESI Code Module 22 may be operable in correcting the error(s), including interfacing with the user and with NLAD and/or NV, without requiring communications to NLAD and/or NV via Telgoo nor via Provider A's system 110.

Referring now to FIG. 4D, an illustrative process of ESI Code Module 22 facilitating correction of an NLAD error is depicted. More specifically, if an NLAD Ineligible_For_Transfer error is received (step 436) (e.g., as discussed above, a subscriber may transfer to a new subscriber no more than once per calendar month), the ESI Code Module 22 may prompt the user to select one of various NLAD-specified exception codes to the error (step 438). If a code is selected by the user, then, for example, ESI Code Module 22 may provide the exception code to Telgoo, which may then perform the Transfer-in transaction (step 440), resulting in a successful transfer of the user in NLAD as a subscriber of Provider A, reflected in NLAD being updated, and resulting in Telgoo updating the ACP Status in its database 144 record for the subscriber to “Enrolled.” (step 442). Alternatively, ESI Code Module 22 may provide the exception code directly to NLAD to perform the subscriber enrollment. Upon successful enrollment, the ESI Code Module may update database 144. If in step 438 the user did not select a code (for whatever reason), then the ESI Code Module 22 will later re-notify the user as to the ineligible-for-transfer error and the exception code option selections. (step 446).

Referring now to FIG. 4E, an illustrative process of ESI Code Module 22 facilitating correction of various illustrative NV errors (e.g., errors precluding ACP eligibility/qualification, and thereby precluding enrollment/reenrollment in ACP through NLAD).

Step 452 represents receipt of a personal information rejection, wherein the user/customer is required to correct their provided personal information, providing relevant proof substantiating the accuracy of the provided personal information (e.g., SSN4, birthday, etc.). To rectify this error (step 460), ESI Code Module 22 may be used to facilitate the user uploading document (e.g. via Telgoo) using their device. For example, ESI Code Module 22 may be used for prompting the customer to provide the required documents to the Telgoo database, and Telgoo may then send the documents to the national verifier (via API or other suitable method), and, as such, the customer does not need to browse to the NV webpage. Alternatively, ESI Code Module 22 may be used to redirect the user's browser to the NV portal, where the user can upload documents via the device, again not requiring the user to browse to the NV portal.

Once customer documents are uploaded to the NV, a review period of a few minutes occurs. During this time, the uploaded documents are reviewed by the national verifier to determine if the initial rejection can be cleared, based on the information contained in the uploaded documents. If the rejection is fixed, approval is given by the national verifier, and the flow continues to step 426 of FIG. 4C. (If not, the flow returns to the previous step, though not explicitly depicted.)

Step 454 represents an invalid address rejection, indicating, for example, that the user address submitted to NV is not recognized as a residential address. To rectify this error, in step 462, the ESI Code Module 22 prompts the user to pinpoint their current address on an online map displayed on their device. In some embodiments, this may be a map displayed to the customer on a national verifier website, though in various embodiments it may be a map displayed on the customer device as prompted by the ESI Code Module 22. Once the customer pinpoints the address, they should receive immediate approval from the NV, viewable directly through the user device, so the process should then proceed to step 426 of FIG. 4C.

Step 456 represents an eligibility rejection, wherein the national verifier was unable to automatically verify the customers participation in a benefit that qualifies them for ACP. Therefore, the NV requires proof of the customer's qualifying program (e.g., proof of Medicaid, or proof of low income). This proof is provided by document upload. As for the personal information rejection (step 452), to rectify this error (step 460), ESI Code Module 22 may be used to facilitate the user uploading documentation (e.g. via Telgoo) using their device. For example, ESI Code Module 22 may be used for prompting the customer to provide the required documents to the Telgoo database (e.g., the document being provide via the device to module 22, which then may provide the documents to Telgoo), and Telgoo may then send the documents to the national verifier (via API or other suitable method). As such, the customer does not need to browse to the NV webpage. Alternatively, ESI Code Module 22 may be used to redirect the user's browser to the NV portal, where the user can upload documents via the device. If the rejection is fixed, approval is given by the NV, and the flow continues to step 426 of FIG. 4C.

Step 458 represents a Duplicant Household error, wherein the address that the customer provided in their original application (which is stored in, e.g., Telgoo and/or Provider A's database 114), is recognized by the NV as currently already receiving an ACP service benefit. Rectifying this error, requires the customer to fill out a household worksheet in order to affirm no one in their household is receiving an ACP benefit.

To rectify this error, the customer may be required to fill out the Household Worksheet. on their device. The ESI Code Module provides for the customer to complete and submit the Household Worksheet directly through their device. For instance, similar to the hereinabove disclosure, the ESI Code Module provides for displaying to the customer on their device an NV webpage having the worksheet on it for completion by the customer/user. In this regard, to further facilitate completion of the worksheet, the ESI Code Module may provide prompts to the customer, and upon the customer responding to the prompts, the ESI Code Module may send the provided worksheet information to the NV. Alternatively or additionally, the worksheet may be stored in the Telgoo and/or Provider A database(s). Completing the worksheet should allow for immediate approval by the NV, so the process should then proceed to step 426 of FIG. 4C.

As represented by step 466, it may be possible for the customer to remedy the various errors by alternatively modifying the personal information they originally provided in applying to the NV, which information may be stored in Telgoo (and/or Provider A's database 114). The updated information is sent to the national verifier and causes the national verifier to perform another eligiblity check. which may resolve the initially received error, resulting in the process proceeding to step 426 of FIG. 4C.

The present invention has been illustrated and described with respect to some specific illustrative embodiments thereof, which embodiments are merely illustrative of some of the principles of some embodiments of the invention and are not intended to be exclusive or otherwise limiting embodiments. Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. For instance, except to the extent necessary or inherent in the processes themselves, no particular order to steps or stages of methods or processes described in this disclosure, including the figures, is implied. In many cases the order of process steps may be varied, and various illustrative steps may be combined, altered, or omitted, without changing the purpose, effect or import of the methods described. Similarly, the structure and/or function of a component may be combined into a single component or divided among two or more components. It is further noted that the terms and expressions have been used as terms of description and not terms of limitation. There is no intention to use the terms or expressions to exclude any equivalents of features shown and described or portions thereof. Additionally, the present invention may be practiced without necessarily providing one or more of the advantages described herein or otherwise understood in view of the disclosure and/or that may be realized in some embodiments thereof. It is therefore intended that the present invention is not limited to the disclosed embodiments but should be defined in accordance with claims that are based on the present disclosure, as such claims may be presented herein and/or in any patent applications claiming priority to, based on, and/or corresponding to the present disclosure.

What is claimed is:

1. A method for a provider of subsidized connectivity services under a subsidized connectivity program to provide a code module to be stored on at least one non-transitory computer-readable medium of a device to be used by a user to access subsidized-connectivity service under the program, wherein the device comprises at least one processor operable in executing the code module to cause at least the following:
monitoring of an enrollment status of the user with respect to the subsidized connectivity program;
based on the monitored enrollment status, selectively prompting the user via the device for a responsive input; and
based on the responsive input and the monitored enrollment status, selectively invoking a change in the enrollment status of the user.

2. The method according to claim 1, wherein monitoring of the enrollment status comprises accessing the enrollment status on a server or database via a network.

3. The method according to claim 2, wherein the server or database is under the operation and control of a third-party with respect to the provider and the user.

4. The method according to claim 2, wherein the server or database is under the operation and control of the provider.

5. The method according to claim 2, wherein the server or database selectively accesses a second server and/or a second database operated by an entity that subsidizes the subsidized connectivity service.

6. The method according to claim 5, wherein the entity is a governmental entity.

7. The method according to claim 1, wherein provider is at least one of an internet service provider, a mobile network operator, a mobile virtual network operator, and a WiFi provider.

8. The method according to claim 1, wherein the monitoring indicates that the user has been transferred to a different service provider of the subsidized-connectivity service, the prompting requests that the user confirm whether the user intended the transfer and/or whether the user wishes to transfer back to the provider, and selectively invoking a change in the enrollment status comprises effecting a transfer transaction causing the user to be enrolled in the program as a user receiving the subsidized-connectivity service from the provider.

9. The method according to claim 1, wherein the monitoring indicates that the user has been de-enrolled from the subsidized connectivity program, the prompting requests that the user confirm whether the user wishes to re-enroll the subsidized connectivity program, and selectively invoking a change in the enrollment status comprises effecting an enrollment transaction causing the user to be enrolled in the program as a user receiving the subsidized-connectivity service from the provider.

10. The method according to claim 9, wherein prompting the user includes requesting that the user to provide additional information that may be needed to effect re-enrollment.

11. The method according to claim 1, further comprising determining whether an application for eligibility the user to be enrolled in the program is needed.
transmitting, via a communications network, the input data to the verification system to determine eligibility of the user for the program based on the input data; and
obtaining from the verification system, via the communications network, authorization data indicating whether the user is approved or denied, wherein if the user is approved the authorization data further comprises an amount of subsidy approved for the user.
